(19) United States
(12) Patent Application Publication
(10) Pub. No.: US 2014/0045538 A1
(43) Pub. Date: Feb. 13, 2014

(54) Self Tuned Paging

(71) Applicants: Lori Eileen Sinclair, Allen, TX (US); Martin David Kendall, Wylie, TX (US)

(72) Inventors: Lori Eileen Sinclair, Allen, TX (US); Martin David Kendall, Wylie, TX (US)

(21) Appl. No.: 13/584,101

(22) Filed: Aug. 13, 2012

(51) Int. Cl. H04W 68/00

(52) U.S. Cl. 455/458

(57) ABSTRACT

A node of a wireless telecommunications network having mobile devices includes a network interface in communication with the network which receives information regarding transition relationships between sector-carriers based on a change in strongest sector-carriers. The node includes a paging database in communication with the network interface which stores the transition relationships information between sector-carriers. The node includes a processing unit in communication with the database which determines a paging area for a page by focusing on those sector-carriers that a mobile device of the mobile devices is likely to be at based on the information regarding transition relationships in the database. A method of a node of a wireless telecommunications network having mobile devices for determining a paging area.

### TECHNICAL FIELD

The present invention relates to determining a paging area for a page by focusing on those sector-carriers that a mobile device is likely to be at based on information regarding transition relationships in a database. (As used herein, references to the “present invention” or “invention” relate to exemplary embodiments and not necessarily to every embodiment encompassed by the appended claims.) More specifically, the present invention relates to determining a paging area for a page by focusing on those sector-carriers that a mobile device is likely to be at based on information regarding transition relationships in a database where the database stores the transition relationships information between sector-carriers.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

When a wireless communications technology, such as LTE, 1xEV-DO, or 1xRTT, needs to locate a User Entity, Access Terminal, or mobile user terminal in order to transfer data, it does this by paging. Some examples of existing LTE paging schemes are Last-Visited eNodeB, Last-Visited Tracking Area, and Tracking Area Identity List. Existing 1xEV-DO) paging schemes, defining which sectors to page, include SubnetWide, Distance Based Paging (DBP), and RouteUpdate Message Based Paging (RUMBP). Some 1xRTT paging schemes are SystemWide, Zone, ZoneList, Last Cell, and Last Active Set paging. Please see the References section.

The large paging schemes, such as TAI List, SubnetWide, and SystemWide, page a large number of sectors in the network to find the mobile device; however, this comes at the expense of network resources, particularly the common broadcast channels of which its unused slots could otherwise be used for data traffic in the case of technologies like LTE and 1xEV-DO. Also, loading channels with pages can lead to mobile device's battery drain and dropped messages, which in turn can lower the page success rate and delay connection setups.

The small paging schemes, such as Last-Visited eNodeB, RUMBP and Last Cell Paging, page the fewest number of sectors and thereby use the least amount of paging resources on the first page, but have less success at reaching the mobile device. Therefore, an unsuccessful first page requires more repaging, which typically uses a larger paging area that can end up using even more paging resources than with a more successful first page. The importance of high page success rates not only is to minimize overall impact to paging resources, but for faster user connect times.

The midsized paging schemes, such as Tracking Area, DBP and Zone, can be configured on a per sector level to try to minimize the paging area while maintaining a good page success rate. However, the paging area is still large relative the small paging schemes, since the chosen Tracking Area Code, RouteUpdateRadiusOverhead, or Registration Zone of each sector-carrier should be set quite large to avoid causing mobile devices to ping-pong register (send Tracking Area Updates, distance based RouteUpdate Messages or Zone Registrations excessively). Also, typically all sectors at a site share the same latitude and longitude, so distance measurements will include all sectors at each site falling within at least the 1xEV-DO RouteUpdateRadiusOverhead. These types of paging schemes are both difficult for operators to determine, configure and maintain, and it still pages an unnecessarily large area.

Other paging algorithms also exist, but they do not determine which sectors to page (the paging area); for example, Frequency Based Paging determines which channels (carriers) on those sectors in the paging area after they have first been determined by the existing paging area paging schemes or the new invention.

### BRIEF SUMMARY OF THE INVENTION

The present invention pertains to a node of a wireless telecommunications network having mobile devices. The node comprises a network interface in communication with the network which receives information regarding transition relationships between sector-carriers based on a change in the strongest sector-carriers. The node comprises a paging database in communication with the network interface which stores the transition relationships information between sector-carriers. The node comprises a processing unit in communication with the database which determines a paging area for a page by focusing on those sector-carriers that a mobile device of the mobile devices is likely to be at based on the information regarding transition relationships in the database.

The present invention pertains to a method of a node of a wireless telecommunications network having mobile devices for determining a paging area. The method comprises the steps of receiving at a network interface of the node in communication with the network information regarding transition relationships between sector-carriers based on a change in the strongest sector-carriers. There is the step of storing in a paging database in communication with the network interface the transition relationships information between sector-carriers. There is the step of determining with a processing unit in communication with the database a paging area for a page by focusing on those sector-carriers that a mobile device of the mobile devices is likely to be at based on the information regarding transition relationships in the database.

### BRIEF DESCRIPTION OF THE DRAWING

In the accompanying drawings, the preferred embodiment of the invention and preferred methods of practicing the invention are illustrated in which:

FIG. 1 shows Paging Areas: Subnetwide vs DBP.

FIG. 2 shows Paging Areas: Self Tuned Paging vs RUMBP.

FIG. 3 shows a signaling diagram regarding Populating 1xEV-DO Paging Database.

FIG. 4 shows a signaling diagram regarding Populating 1xEV-DO Paging Database

FIG. 5 is a block diagram of a node of the present invention.

FIG. 6 is a schematic representation of a network with a node and mobile devices.

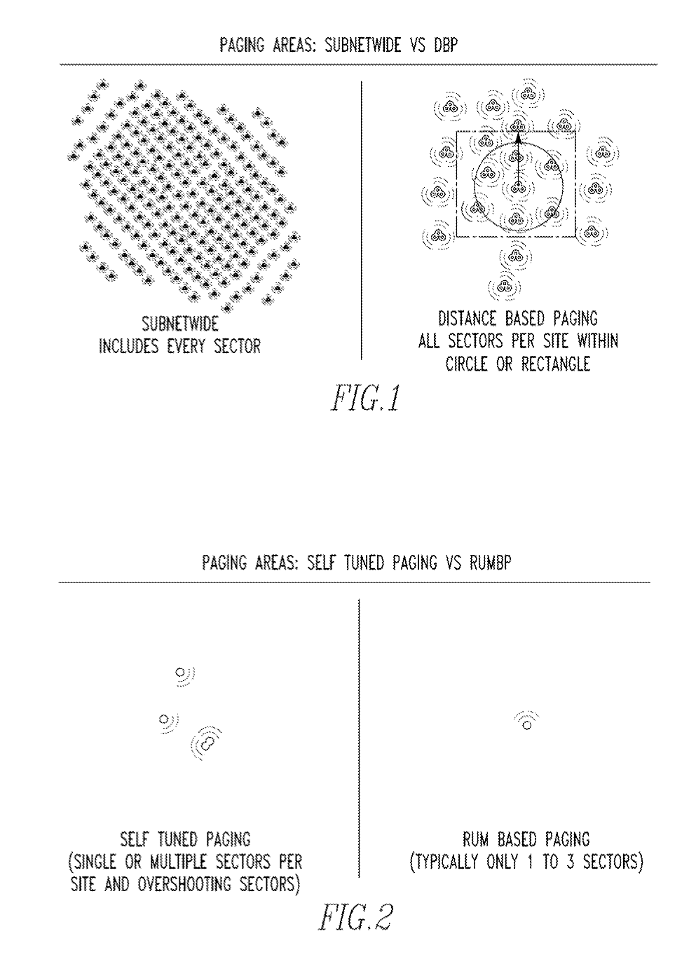

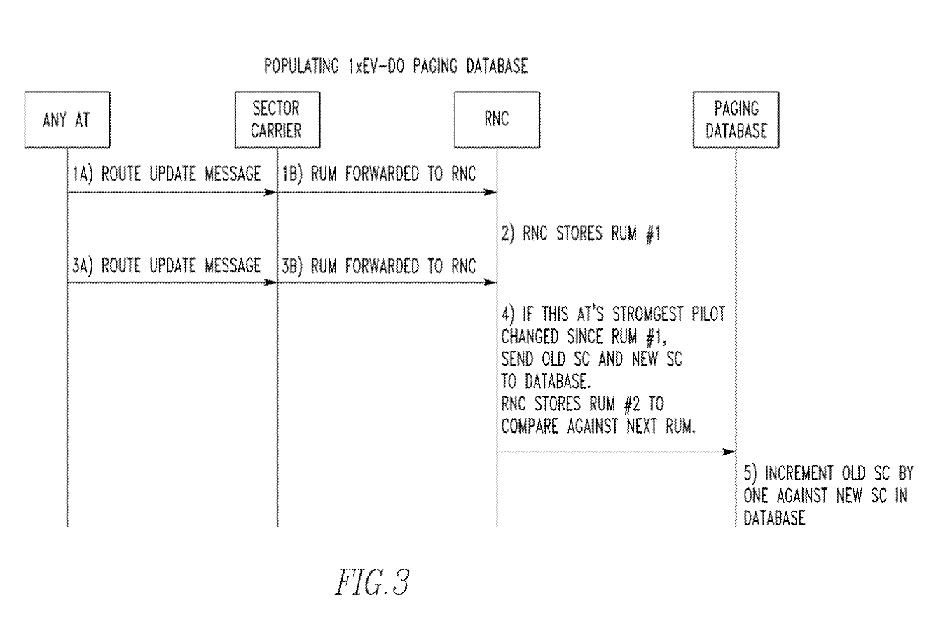

### DETAILED DESCRIPTION

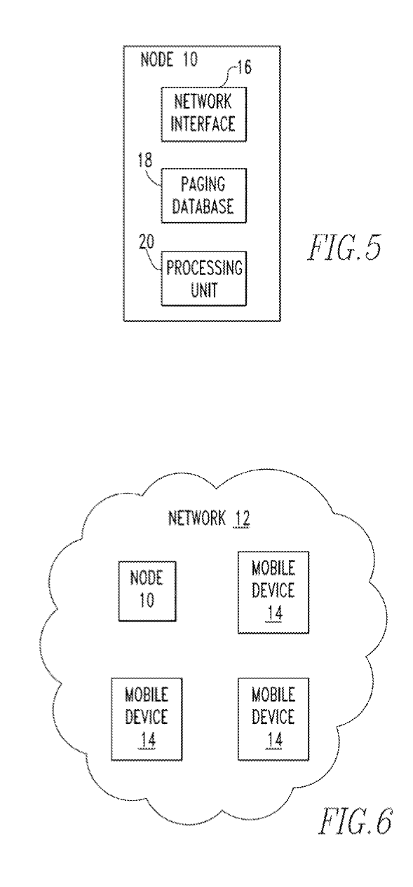

Referring now to the drawings wherein like reference numerals refer to similar or identical parts throughout the several views, and more specifically to FIGS. 5 and 6 thereof, there is shown a node 10 of a wireless telecommunications network 12 having mobile devices 14. The node 10 comprises a network interface 16 in communication with the network 12 which receives information regarding transition relationships between sector-carriers based on a change in the strongest sector-carriers. The node 10 comprises a network interface 16 in communication with the paging database 18, which stores the transition relationships information between sector-carriers. The node 10 comprises a processing unit 20 in communication with the paging database which determines a paging area for a page by focusing on those sector-carriers that a mobile device 14 is likely to be at based on the information regarding transition relationships in the paging database.

The processing unit 20 may determine the paging area for the page by focusing on those sector-carriers that the mobile device 14 is most likely to move to from the sector-carrier when the mobile device 14 is in an idle state. The transition relationships between sector-carriers may be based on a change in strongest sector-carriers from any mobile device 14 measurements in the network while those mobile devices 14 are in traffic or idle.

The processing unit 20 may begin using the information regarding the transition relationships after the database has been populated with enough transition relationship information to satisfy a paging database 18 sample size. The processing unit 20 may use a transition percentage for each page attempt. The processing unit 20 may use a larger or equal transition percentage for a second page attempt than transition percentage for a first page attempt. Likewise, third page attempt may use a larger or equal transition percentage than the second.

The present invention pertains to a method of a node 10 of a wireless telecommunications network 12 having mobile devices 14 for determining a paging area. The method comprises the steps of receiving at a network interface 16 of the node 10 in communication with the network 12 information regarding transition relationships between sector-carriers based on a change in strongest sector-carriers. There is the step of storing in a paging database 18 in communication with the network interface 16 the transition relationships information between sector-carriers. There is the step of determining with a processing unit 20 in communication with the database a paging area for a page by focusing on those sector-carriers that a mobile device 14 of the mobile devices 14 is likely to be at based on the information regarding transition relationships in the database.

There may be the step of the processing unit 20 determining the paging area for the page by focusing on those sector-carriers that the mobile device 14 is most likely to move to from the sector-carrier when the mobile device 14 is in an idle state. The transition relationships between sector-carriers may based on a change in strongest sector-carriers from any mobile device 14 measurements in the network while the mobile device 14 is in traffic or idle.

There may be the step of the processing unit 20 begins using the information regarding the transition relationships after the database has been populated with enough transition relationship information to satisfy a paging database 18 sample size. There may be the processing unit 20 using a transition percentage for each page attempt. There may be the step of the processing unit 20 using a larger or equal transition percentage for a second page attempt than transition percentage for a first page attempt.

In the operation of the invention, the Self Tuned Paging scheme intelligently pages only those sectors on which the paged mobile device 14 is most likely to be idling, thereby achieving a high page success rate with minimized cost in paging resources and no detailed analysis required of operators. It does not blindly waste resources by applying a blanket circular or rectangular shape bounded by latitude and longitude (such as Tracking Area, DBP, or Zone), but rather it caters to the irregular pattern of RF signals beyond the limited scope of constrained paging areas (such as Last-Visited eNodeB, RUMBP or Last Cell Paging). Self Tuned Paging provides an improved page success rate over the small paging schemes while using less paging resources than the midsized and large paging schemes by choosing sectors very selectively based on measurements reported by the terminals.
1. For each sector-carrier, the Access Network builds up a Paging database 18 which stores transition relationships between sector-carriers, and is based on a change in strongest sector-carriers received from any mobile device 14 measurements in the network while in traffic or idle. This method is different than tuning a NeighborList in 1xEV-DO: while a NeighborList is more inclusive of sector-carriers (reference sector plus all other sectors in the Route Update Message) to avoid interference when in traffic, the Paging database 18 is more particular in its selection of sector-carriers to minimize the size of the paging area by focusing only on those sector-carriers that mobile device 14 are most likely to move to from this sector-carrier in idle state. For LTE, the sector-carrier relationships can be obtained from the Automatic Neighbor Relations or the like.
2. Until this Paging database 18 has enough entries to be statistically significant (either a hardcoded or configurable limit—call it PD Sample Size), page the sectors using one of these two following options per page attempt. Option#1: page just those sectors using one of the smallest paging schemes, such as LTE's Last-Visited eNobeB or 1xEV-DOs RUMBP. Option#2: page the entire NeighborList of the strongest sector of the last RUM for 1xEV-DO, or entire Automatic Neighbor Relations for LTE. For example, Option#1 can be selected for the first page attempt, and Option#2 for the second page attempt.
3. Once the Paging database 18 has been populated with enough entries to satisfy the PD Sample Size, then no longer use Option#1 or Option#2. Instead use a Transition Percentage, which can be configured differently from 0 to 100% for each page attempt. This Transition Percentage defines how many (relative to a Cumulative Distribution Function) of the neighbors in the Paging database 18 should be paged. For example, the second page attempt could have a larger Transition Percentage than that of the first page attempt, so that it would page a larger paging area on the repage in case the mobile device 14 had moved beyond the first area. Build the paging area using this technique for each sector-carrier in the paged mobile devices 14 last sector-carrier measurement report, but do not add the same sector-carrier more than once to the paging area.

Example Paging database 18 entry for IP x.x.x.1 sector 0, and resulting Cumulative Distribution Function:
x.x.x.2_s0 1000 (=1000/1600=63%)
x.x.x.3_s2 400 (=88%)
x.x.x.4 s0 200 (=100%)

So in this example, if the Transition Percentage <=63%, then the network would page x.x.x.1_s0 and x.x.x.2_s0. If the Transition Percentage >63% but <=88%, then the network would page x.x.x.1_s0, x.x.x.2_s0, and x.x.x.3_s2. If the Transition Percentage >88%, then the network would page x.x.x.1_s0, x.x.x.2_s0, x.x.x.3_s2, x.x.x.4_s0.
4. Sometimes the mobile device's last sector-carrier measurement report may contain some sector-carrier entries that satisfy the PD Sample Size and others that do not. So use the Transition Percentage for those sector-carriers that do, but use Option#1 or #2 (whichever is configured) for those that do not.

Paging with precision is the key to minimizing how much paging resource is used while at the same time reaching the mobile device 14 as quickly as possible for best individual user performance in terms of user perceived data throughput. RF signals do not adhere to a specific shape that is used by the other paging schemes. For instance, a sector poised high on a hill may shoot into some unexpected areas, but the Self Tuned Paging database 18 entries will account for those sectors and exclude those sectors in between to both preserve paging resources and page with high success.

Populating 1xEV-DO Paging Database (FIG. 3):

1) A mobile device sends a Route Update Message (RUM) containing sector-carrier information, such as pilot PN and strength, to the network. The RN (sector-carrier) forwards this information to the RNC.

The following is an example RUM on ACH. The strongest pilot is the only pilot PN=21:

2012 Jun 26 06:22:40.695 [00] 0x1076 1xEV Signaling Access Channel -
RouteUpdateMsg

| | | |
|---|---|---|
| Band = 1 | Chan Num = 1075 | Pilot PN = 21 |
| HSTR = 0 | Reliable = 0 | Fragmented = 0 |
| AckSeq # Valid = 0 | Seq # Valid = 0 | SyncCCFlag = 0 |
| Ack Seq No = 0 | Seq No = 255 | App SubType = 0 |

IS890 (TAPP) = 0
header_rev = 1 (0x1)
num_options = 0 (0x0)
subtype = 0 (0x0) (subtype 0)
protocol_instance = 0 (0x0) (In Use)
protocol_type = 14 (0xe) (Route Update Protocol)
message_id = 0 (0x0) (RouteUpdate)
route_update
update
message_sequence = 197 (0xc5)
reference_pilot_pn = 21 (0x15)
reference_pilot_strength = 4 (0x4) (−2.0 dB)
reference_keep = 1 (0x1)
num_pilots = 0 (0x0)

2) The RNC stores this RUM #1 along with the other session information about this mobile device. The RNC stores session information and last RUMs for all mobile devices.

3) This same mobile device sends another RUM #2 to this or another sector-carrier in the network.

Here is next RUM on TCH, where the reference pilot (sector-carrier) is no longer the strongest but rather PN=357 (=22848/64) is.

2012 Jun 26 06:22:41.485 [00] 0x1077 1xEV Signaling Reverse Traffic
Channel - RouteUpdateMsg

| Band = 1 | Chan Num = 1075 Pilot PN = 21 | |
|---|---|---|
| HSTR = 3584 | Reliable = 1 | Fragmented = 0 |
| AckSeq # Valid = 0 | Seq # Valid = 1 | SyncCCFlag = 0 |
| Ack Seq No = 0 | Seq No = 2 | App SubType = 0 |
| IS890 (TAPP) = 0 | | |

```
header_rev = 1 (0x1)
num_options = 0 (0x0)
subtype = 0 (0x0) (subtype 0)
protocol_instance = 0 (0x0) (In Use)
protocol_type = 14 (0xe) (Route Update Protocol)
message_id = 0 (0x0) (RouteUpdate)
route_update
  update
message_sequence = 198 (0xc6)
reference_pilot_pn = 21 (0x15)
reference_pilot_strength = 9 (0x9) (−4.5 dB)
reference_keep = 1 (0x1)
num_pilots = 2 (0x2)
  pilots[0]
pilot_pn_phase = 22848 (0x5940)
channel_included = 0 (0x0)
pilot_strength = 8 (0x8) (−4.0 dB)
    keep = 1 (0x1)
  pilots[1]
pilot_pn_phase = 22464 (0x57c0)
channel_included = 0 (0x0)
pilot_strength = 22 (0x16) (−11.0 dB)
    keep = 1 (0x1)
```

4) Since the strongest pilot (sector-carrier) has changed, now RNC notifies the Paging Database of these two sector-carriers. RNC stores this new RUM #2 as its latest RUM in the session information for this mobile device.

5) Paging Database looks up the IP address and sector-carrier PN 21 Channel 1075 entry and increments its column containing the IP address sector-carrier PN 357 Channel 1075 by one. All mobile devices contribute to updating the Paging Database for any sector-carrier transition between strongest pilots.

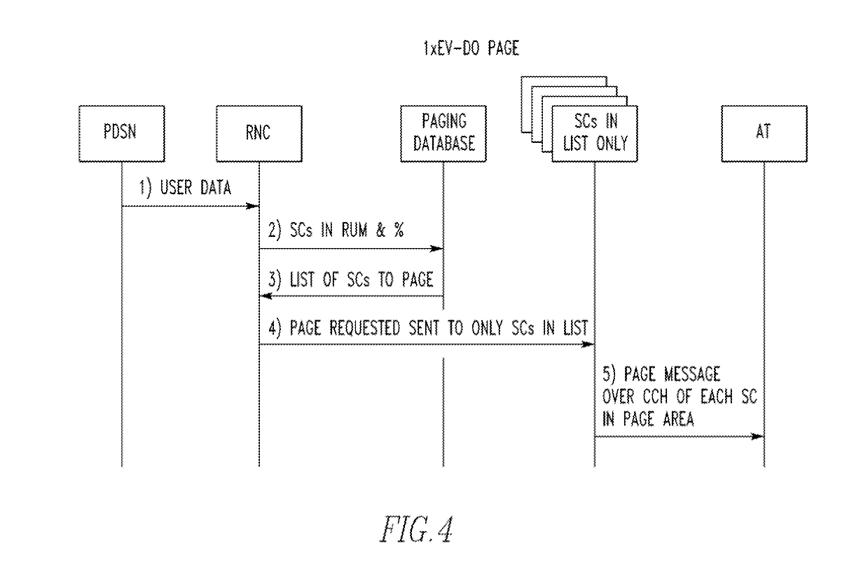

1xEV-DO Page (FIG. 4):

1) PDSN notifies the RNC that user data needs to be sent down to a particular subscriber's mobile device.

2) The RNC looks up this mobile device's session information for the last RUM received from this mobile device. For each pilot in the RUM, the RNC queries the Paging Database to provide a list of sector-carriers based on a given Transition Percentage.

This Transition Percentage defines how many (relative to a Cumulative Distribution Function) of the neighbors in the Paging Database should be paged. Build the paging area using this method for each sector-carrier in the paged mobile devices last sector-carrier measurement report, but do not add the same sector-carrier more than once to the paging area.

Example Paging Database entry for IP x.x.x.1 sector 0, and resulting Cumulative Distribution Function:
x.x.x.2_s0 1000 (=1000/1600=63%)
x.x.x.3_s2 400 (=88%)
x.x.x.4_s0 200 (=100%)

So in this example, if the Transition Percentage <=63%, then the network would page x.x.x.1_s0 and x.x.x.2_s0. If the Transition Percentage >63% but <=88%, then the network would page x.x.x.1_s0, x.x.x.2_s0, and x.x.x.3_s2. If the Transition Percentage >88%, then the network would page x.x.x.1_s0, x.x.x.2_s0, x.x.x.3_s2, x.x.x.4_s0.

3) For those sector-carriers with enough transitions to satisfy the PD Sample Size, the Paging Database sends a list of sector-carriers to the RNC. If there are not enough transitions, the Paging Database returns an insufficient sample indicator to the RNC.

4) The RNC sends page requests to only those sector-carriers in the list, or determines its own list if an insufficient sample indicator is returned.

5) Only those sector-carriers from step #4 send a page out over the air on the Control Channel specifying this mobile device's UATI.

Some benefits of a lower paging occupancy gained by Self Tuned Paging include:
faster data throughput, since unused slots can be used by traffic
faster connect times, since messages can be sent out earlier without waiting for other wasteful pages
improved mobile device 14 battery life by reducing the number of pages, which all mobile devices 14 must stay awake to read
less page message drops, which may improve page success rates
reduced CPU load on network and strain on backhaul resources, since less pages to schedule and process

### ABBREVIATIONS

AT—Access Terminal
CCH—Control Channel
CPU—Central Processing Unit
DBP—Distance Based Paging
RF—Radio Frequency
RUM—Route Update Message
RUMBP—Route Update Message Based Paging

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A node of a wireless telecommunications network having mobile devices, the node comprising:
a network interface in communication with the network which receives information regarding transition relationships between sector-carriers based on a change in strongest sector-carriers;
a paging database in communication with the network interface which stores the transition relationships information between sector-carriers; and
a processing unit in communication with the database which determines a paging area for a page by focusing on those sector-carriers that a mobile device of the mobile devices is likely to be at based on the information regarding transition relationships in the database.

2. The node of claim 1 wherein the processing unit determines the paging area for the page by focusing on those sector-carriers that the mobile device is most likely to move to from the sector-carrier when the mobile device is in an idle state.

3. The node of claim 2 wherein the transition relationships between sector-carriers is based on a change in strongest sector-carriers from mobile device measurements while the mobile device is in traffic or idle.

4. The node of claim 3 wherein the processing unit begins using the information regarding the transition relationships after the database has been populated with enough transition relationship information to satisfy a paging database sample size.

5. The node of claim 4 wherein the processing unit uses a transition percentage for each page attempt.

6. The node of claim 5 wherein the processing unit uses a larger than or equal transition percentage for a second page attempt than transition percentage for a first page attempt. Likewise, third page attempt may use a larger than or equal transition percentage than the second.

7. A method of a node of a wireless telecommunications network having mobile devices for determining a paging area, the method comprising the steps of:
receiving at a network interface of the node in communication with the network information regarding transition relationships between sector-carriers based on a change in strongest sector-carriers;
storing in a paging database in communication with the network interface the transition relationships information between sector-carriers; and
determining with a processing unit in communication with the database a paging area for a page by focusing on those sector-carriers that a mobile device of the mobile devices is likely to be at based on the information regarding transition relationships in the database.

8. The method of claim 7 including the step of the processing unit determining the paging area for the page by focusing on those sector-carriers that the mobile device is most likely to move to from the sector-carrier when the mobile device is in an idle state.

9. The method of claim 8 wherein the transition relationships between sector-carriers is based on a change in strongest sector-carriers from mobile device measurements while the mobile device is in traffic or idle.

10. The method of claim 9 including the step of the processing unit begins using the information regarding the transition relationships after the database has been populated with enough transition relationship information to satisfy a paging database sample size.

11. The method of claim 10 including the processing unit using a transition percentage for each page attempt.

12. The method of claim 11 including the step of the processing unit using a larger than or equal transition percentage for a second page attempt than transition percentage for a first page attempt.
